(19) United States
(12) Patent Application Publication
(10) Pub. No.: US 2026/0358991 A1
(43) Pub. Date: Nov. 12, 2026

(54) LIVE STREAMING PROCESSING METHOD, SYSTEM, CLIENT, SERVER, ELECTRONIC DEVICE AND MEDIUM

(71) Applicant: Beijing Zitiao Network Technology Co., Ltd., Beijing (CN)

(72) Inventors: Xuechao ZHI, Beijing (CN); Rentao ZHANG, Beijing (CN)

(21) Appl. No.: 19/672,548

(22) Filed: May 8, 2026

(30) Foreign Application Priority Data
May 9, 2025 (CN) 202510600559.6

(51) Int. Cl. G06F 3/14

(52) U.S. Cl. CPC G06F 3/14

(57) ABSTRACT

The present disclosure relates to a live streaming processing method, a system, a client, a server, an electronic device, and a medium, and to the field of computer technologies. The live streaming processing method of the present disclosure may be performed by a client, and includes: obtaining user interface (UI) elements and information about display areas of a plurality of first live streaming users participating in interactive live streaming, wherein audio streams of the plurality of first live streaming users are output as a merged stream in the interactive live streaming, and the plurality of first live streaming users and the information about the display area of each first live streaming user of the plurality of first live streaming users are determined according to audio quality information of the each first live streaming user; generating a first display position corresponding to the each first live streaming user according to the information about the display area of the each first live streaming user; and displaying the UI element of the each first live streaming user at the first display position corresponding to the each first live streaming user.

### CROSS-REFERENCE TO RELATED APPLICATIONS

This application claims the benefit under 35USC 119 (a) of Chinese Patent Application No. 202510600559.6, filed on May 9, 2025. The entire disclosure of the prior application is incorporated herein by reference in its entirety.

### TECHNICAL FIELD

The present disclosure relates to the field of computer technologies, and in particular, to a live streaming processing method and system, a client, a server, an electronic device, and a medium.

### BACKGROUND

When a plurality of live streaming users participate in interactive live streaming, a plurality of live streaming streams (video streams or audio streams) of the plurality of live streaming users may be merged and played on a client. The plurality of live streaming users participating in the interactive live streaming may interact in real time through a connection (or referred to as microphones connection), and therefore, the interactive live streaming may include live streaming connection (or live streaming microphones connection). An audience may join a live channel of the interactive live streaming to watch the interactive live streaming. Information about the plurality of live streaming users may be displayed on a display interface of the interactive live streaming.

### SUMMARY

According to some embodiments of the present disclosure, a live streaming processing method is provided. The method is performed by a client and includes: obtaining user interface (UI) elements and information about display areas of a plurality of first live streaming users participating in interactive live streaming, wherein audio streams of the plurality of first live streaming users are output as a merged stream in the interactive live streaming, and the plurality of first live streaming users and the information about the display area of each first live streaming user of the plurality of first live streaming users are determined according to audio quality information of the each first live streaming user; generating a first display position corresponding to the each first live streaming user according to the information about the display area of the each first live streaming user; and displaying the UI element of the each first live streaming user at the first display position corresponding to the each first live streaming user.

According to some other embodiments of the present disclosure, a live streaming processing method is provided. The method is performed by a server and includes: receiving audio quality information of a plurality of live streaming users sent by clients of the plurality of live streaming users participating in interactive live streaming; determining a plurality of first live streaming users and information about a display area of the each first live streaming user of the plurality of live streaming users according to the audio quality information of the plurality of live streaming users, wherein the plurality of first live streaming users are part or all of the plurality of live streaming users, and audio streams of the plurality of first live streaming users are output as a merged stream in the interactive live streaming; and sending user interface (UI) elements of the plurality of first live streaming users and the information about the display area of the each first live streaming user to all clients to display the UI element of the each first live streaming user in the display area of the each first live streaming user.

According to still some embodiments of the present disclosure, a client is provided. The client includes: an obtaining module configured to obtain user interface (UI) elements and information about display areas of a plurality of first live streaming users participating in interactive live streaming, wherein audio streams of the plurality of first live streaming users are output as a merged stream in the interactive live streaming, and the plurality of first live streaming users and the information about the display area of each first live streaming user of the plurality of first live streaming users are determined according to audio quality information of the each first live streaming user; a generation module configured to generate a first display position corresponding to the each first live streaming user according to the information about the display area of the each first live streaming user; and a display module configured to display the UI element of the each first live streaming user at the first display position corresponding to the each first live streaming user.

According to yet some embodiments of the present disclosure, a server is provided. The server includes: a receiving module configured to receive audio quality information of a plurality of live streaming users sent by clients of the plurality of live streaming users participating in interactive live streaming; a determination module configured to determine a plurality of first live streaming users and information about a display area of the each first live streaming user according to the audio quality information of the plurality of live streaming users, wherein the plurality of first live streaming users are part or all of the plurality of live streaming users, and audio streams of the plurality of first live streaming users are output as a merged stream in the interactive live streaming; and a sending module configured to send the UI elements of the plurality of first live streaming users and the information about the display area of the plurality of first live streaming users to all clients to display the UI element of the each first live streaming user in the display area of the each first live streaming user.

According to still some embodiments of the present disclosure, a live streaming processing system is provided. The system includes: the client according to any one of the embodiments of the present disclosure and the server according to any one of the embodiments of the present disclosure.

According to yet some embodiments of the present disclosure, an electronic device is provided. The electronic device includes: one or more processors; and one or more memories coupled to the one or more processors and configured to store instructions that, when executed by the one or more processors, cause the processor to perform the live streaming processing method according to any one of the embodiments of the present disclosure.

According to still some embodiments of the present disclosure, a non-transitory computer-readable storage medium having a computer program stored thereon, wherein the program, when executed by a processor, cause the processor to implement the live streaming processing method according to any one of the embodiments of the present disclosure.

Other features, aspects, and advantages of the present disclosure become apparent with reference to the following detailed description of exemplary embodiments of the present disclosure and in conjunction with the drawings.

### BRIEF DESCRIPTION OF THE DRAWINGS

Embodiments of the present disclosure are described hereinafter with reference to the drawings. It should be understood that the drawings in the following description relate to only some embodiments of the present disclosure, and do not constitute a limitation on the present disclosure. In the drawings:

FIG. 1 is a schematic flowchart of a live streaming processing method according to some embodiments of the present disclosure;

FIG. 2 is a schematic diagram of a display interface of interactive live streaming according to some embodiments of the present disclosure;

FIG. 3 is a schematic diagram of a display interface of interactive live streaming according to some other embodiments of the present disclosure;

FIG. 4 is a schematic flowchart of a live streaming processing method according to some other embodiments of the present disclosure;

FIG. 5 is a schematic diagram of a layout of display areas according to some embodiments of the present disclosure;

FIG. 6 is a schematic flowchart of a live streaming processing method according to still some embodiments of the present disclosure;

FIG. 7 is a schematic diagram of a structure of a client according to some embodiments of the present disclosure;

FIG. 8 is a schematic diagram of a structure of a server according to some embodiments of the present disclosure;

FIG. 9 is a schematic diagram of a structure of a live streaming processing system according to some embodiments of the present disclosure;

FIG. 10 is a schematic diagram of a structure of an electronic device according to some embodiments of the present disclosure;

FIG. 11 is a schematic diagram of a structure of an electronic device according to some other embodiments of the present disclosure.

### DETAILED DESCRIPTION

Reference is made to the drawings, and the technical solutions in embodiments of the present disclosure are described clearly and comprehensively. It should be understood that the present disclosure may be implemented in various forms, and should not be construed as being limited to the embodiments set forth herein.

It should be understood that the steps described in method implementations of the present disclosure may be performed in different orders and/or in parallel. In addition, the method implementations may include additional steps and/or omit the steps shown. The scope of the present disclosure is not limited in this regard. Unless otherwise specified, the relative arrangements of the steps set forth in these embodiments should be construed as merely exemplary and do not limit the scope of the present disclosure.

The term “include/comprise” and the variants thereof used in the present disclosure are open terms that mean “include/comprise at least the following elements/features, but do not exclude other elements/features”, that is, “include/comprise but not limited to”. The term “based on” means “based at least in part on”.

It should be noted that concepts such as “first” and “second” mentioned in the present disclosure are merely used to distinguish between different apparatuses, modules, or units, and are not used to limit an order or interdependence of functions performed by these apparatuses, modules, or units. Unless otherwise specified, concepts such as “first” and “second” are not intended to imply that objects described as such must be in a given order in terms of time, space, ranking, or any other manner.

It should be noted that the modifications of “one” and “a plurality of” mentioned in the present disclosure are illustrative rather than restrictive, and those skilled in the art should understand that they should be construed as “one or more” unless otherwise clearly indicated in the context.

The names of messages or information exchanged between a plurality of apparatuses in the implementations of the present disclosure are used for illustrative purposes only, and are not used to limit the scope of the messages or information.

Embodiments of the present disclosure are described in detail hereinafter with reference to the drawings, but the present disclosure is not limited to these specific embodiments. The specific embodiments may be combined with each other, and the same or similar concepts or processes may not be described again in some embodiments. In addition, in one or more embodiments, specific features, structures, or characteristics may be combined in any suitable manner that will be clear to those of ordinary skill in the art from the present disclosure.

In interactive live streaming, live streaming streams of a plurality of live streaming users participating in the interactive live streaming are merged and broadcast on a client of a live streaming user or an audience. The live streaming streams may include video streams or audio streams. In a case where the live streaming streams are audio streams, UI (User Interface) elements such as identification information about the plurality of live streaming users may be displayed on an image of the interactive live streaming, for example, avatars, names, etc. of the plurality of live streaming users. Display positions of the UI elements of the plurality of live streaming users in the image of the interactive live streaming may be referred to as microphone positions. At present, the display positions of the UI elements of the plurality of live streaming users in the image of live streaming image are fixed, and the display positions are generally allocated according to an order in which the plurality of live streaming users join. This display mode is relatively monotonous, and cannot match real-time interactivity of the interactive live streaming, making the image of the interactive live streaming not attractive enough to the audience. In view of some interactive live streaming involving a large number of live streaming users, due to a limitation on an image size, only the UI elements of some live streaming users may be displayed. If the UI elements are fixedly displayed, the UI elements of other live streaming users cannot be displayed. In addition, some live streaming users who join the interactive live streaming rarely speak and contribute little output, and thus only displaying the UI elements of some live streaming users is inaccurate and incomplete, and it is difficult to match the real-time interactivity of the interactive live streaming.

In view of this, the present disclosure provides a live streaming processing method. A client may obtain user interface (UI) elements and information about display areas of a plurality of first live streaming users participating in interactive live streaming, generate a first display position corresponding to each first live streaming user according to the information about the display area of each first live streaming user, and then display the UI element of each first live streaming user at the first display position corresponding to each first live streaming user. Since the plurality of first live streaming users and the information about the display area of each first live streaming user are determined according to audio quality information of each first live streaming user, and real-time interaction of the plurality of live streaming users may lead to changes in the audio quality information, the plurality of first live streaming users and the display areas thereof may also change with the audio quality information. Thus, information displayed on a display interface of the interactive live streaming is more effective, matches real-time interactivity of the interactive live streaming, and meets viewing requirements of the live streaming users or an audience better. Participation states and participation effects of the live streaming users in the interactive live streaming are displayed more vividly, and an overall display effect of the interface of the interactive live streaming is improved.

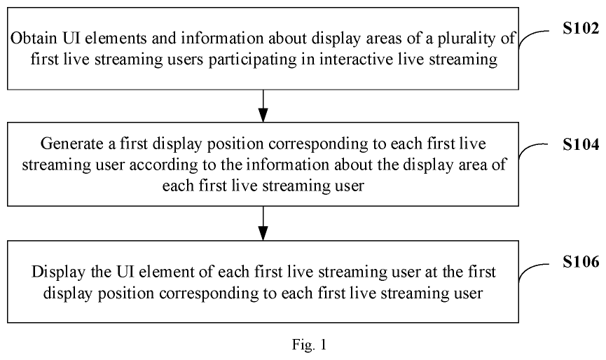

The live streaming processing method of the present disclosure is described hereinafter with reference to FIGS. 1 to 6.

FIG. 1 is a flowchart of some embodiments of a live streaming processing method according to the present disclosure. As shown in FIG. 1, the method in these embodiments includes steps S102 to S106. The method in these embodiments may be performed by a client. The client may be provided in various forms of electronic devices such as a user terminal, and may be a client of a live streaming user or a client of an audience.

In step S102, user interface (UI) elements and information about display areas of a plurality of first live streaming users participating in interactive live streaming are obtained.

The live streaming users participating in the interactive live streaming, that is, users performing live streaming connection (microphones connection), may be streamers, guests, etc. For example, the plurality of first live streaming users may be part or all of all live streaming users participating in the interactive live streaming. Audio streams of the plurality of first live streaming users may be output as a merged stream in the interactive live streaming. For an audience, voices of the plurality of first live streaming users may be heard in the interactive live streaming. For example, the plurality of first live streaming users and the information about the display area of each first live streaming user of the plurality of first live streaming users are determined according to audio quality information of each first live streaming user. The plurality of first live streaming users may be selected from all live streaming users according to audio quality information of all live streaming users participating in the interactive live streaming. The audio quality information may be used to represent advantages and disadvantages of performance of an input audio of a user in one or more aspects such as content, signal, and features.

For example, the information about the display area of each first live streaming user may include an identification (for example, a number) of the display area. A plurality of display areas may be pre-laid out on a display interface of the interactive live streaming, and the UI elements of the live streaming users may be displayed in the display areas. For example, 11 display areas may be laid out on the display interface, and UI elements of 11 live streaming users may be displayed each time. A correspondence between the UI elements of the plurality of first live streaming users and the plurality of display areas may be determined according to the audio quality information of the plurality of first live streaming users. Since the display areas are different in position on the display interface, a display area closer to the center is more likely to be noticed by an audience, and therefore, different display areas may be prioritized and numbered according to attention of the audience. For example, a display area closer to the center of the plurality of display areas has a higher priority. Further, display areas of different priorities are allocated to the plurality of first live streaming users according to the audio quality information of the plurality of first live streaming users.

For example, the UI element of each first live streaming user includes at least one of an avatar, a name, an ID, a decoration material, an effect material, a number of followers, or a number of likes, etc. The UI element may be configured by the live streaming user, or may be generated for the live streaming user based on specific rules (for example, according to the audio quality information), which is not limited to the examples shown.

The client may obtain the UI elements and the information about the display areas of the plurality of first live streaming users from a server. The client may also obtain the UI elements and the audio quality information of the plurality of first live streaming users from the server, and determine the information about the display areas of the plurality of first live streaming users according to the audio quality information.

In step S104, a first display position corresponding to each first live streaming user is generated according to the information about the display area of each first live streaming user.

For example, the first display position corresponding to each first live streaming user may be randomly generated in the display area of each first live streaming user, or may be generated for each first live streaming user according to a specific rule. Randomly generating the first display position corresponding to each first live streaming user may make the first display positions of the first live streaming users on the display interface of the interactive live streaming more flexible and changeable, and different display effects may be presented on different clients, thereby increasing interestingness. The first display position may be represented by coordinates, and the first display position may be used to represent coordinates of a center point of the UI element of the first live streaming user.

In step S106, the UI element of each first live streaming user is displayed at the first display position corresponding to each first live streaming user.

If UI elements of a plurality of live streaming users are currently displayed on the display interface of the interactive live streaming, the UI element of each first live streaming user may be switchingly displayed to present a dynamic switching display effect of the plurality of live streaming users on the display interface.

In the live streaming processing method in the embodiments described above, since the plurality of first live streaming users and the information about the display area of each first live streaming user are determined according to the audio quality information of each first live streaming user, and the real-time interaction of the plurality of live streaming users may lead to the changes in the audio quality information, the plurality of first live streaming users and the display areas thereof may also change with the audio quality information. Thus, the information displayed on the display interface of the interactive live streaming is more effective, matches the real-time interactivity of the interactive live streaming, and meets the viewing requirements of the live streaming users or the audience better. The participation states and the participation effects of the live streaming users in the interactive live streaming are displayed more vividly, and the overall display effect of the interface of the interactive live streaming is improved. In addition, the first display position of each first live streaming user is generated by the client, as opposed to determining the first display position of each first live streaming user in a unified manner by the server and sending the first display position of each first live streaming user from the server to the client, such that the display interface of the client is better adapted and flexibility is improved.

In the two cases where the client is a client of a live streaming user and a client of an audience, there may be some differences in an interaction procedure between the client and the server, which is described hereinafter with reference to some embodiments.

In some embodiments, the live streaming processing method further includes: determining, in response to the client being a client of a live streaming user participating in the interactive live streaming, audio quality information of the live streaming user according to audio (voice) data of the live streaming user in a current period; and sending the audio quality information of the live streaming user to the server, where the server determines the plurality of first live streaming users and the display area of each first live streaming user according to audio quality information of all live streaming users participating in the interactive live streaming, and the plurality of first live streaming users are part or all live streaming users.

For the client of the live streaming user, audio quality information of the live streaming user needs to be reported to the server periodically, so that the server determines the plurality of first live streaming users and the display area of each first live streaming user. For the client of the audience, there is no need to report audio quality information, and it is only necessary to receive the user interface (UI) elements and the information about the display areas of the plurality of first live streaming users, and perform the method for generating the first display position corresponding to each first live streaming user and displaying the UI element of each first live streaming user.

The client of the live streaming user periodically reports the audio quality information, periodically obtains the information about the display areas of the plurality of first live streaming users, and then periodically switchingly displays the UI elements of different live streaming users, such that the information displayed on the display interface of the interactive live streaming better matches the real-time interactivity of the interactive live streaming, and meets the viewing requirements of the live streaming user or the audience better. Flexibility and vividness of information display on the display interface are improved, and interestingness is increased, thereby attracting the audience to watch.

The client may obtain the UI elements and the information about the display areas of the plurality of first live streaming users through different interaction procedures, which is described below with reference to some embodiments.

In some embodiments, obtaining the UI elements and the information about the display areas of the plurality of first live streaming users participating in the interactive live streaming includes: receiving, in response to a live streaming user or an audience of the client entering a live channel of the interactive live streaming, the UI elements and the information about the display areas of the plurality of first live streaming users sent by the server; and/or receiving the UI elements and the information about the display areas of the plurality of first live streaming users sent by the server in a current period.

The client may periodically receive information about display areas of a plurality of live streaming users to be displayed sent by the server. The plurality of live streaming users to be displayed may change in different periods. The plurality of live streaming users to be displayed include the plurality of first live streaming users. For example, for the client of the live streaming user, in response to the live streaming user joining the interactive live streaming, the UI elements and the information about the display areas of the plurality of first live streaming users sent by the server may be received; and after the audio quality information of the live streaming user in the current period is sent to the server, the UI elements and the information about the display areas of the plurality of first live streaming users sent by the server are received in the current period.

For example, the client may receive a Webcast Room Data Sync (WRDS) message sent by the server, where the WRDS message includes the UI elements and the information about the display areas of the plurality of first live streaming users. Through the WRDS message, a change in full service state data of the server may quickly reach all audience and live streaming users in the live channel within a lifecycle of the live channel being live.

According to the method in the above embodiments, it may be ensured that the client may timely and accurately obtain the UI elements and the information about the display areas of the plurality of first live streaming users, so that the UI elements of the plurality of first live streaming users may be timely and accurately displayed.

How the client generates the first display position corresponding to each first live streaming user is specifically described below.

In some embodiments, generating the first display position corresponding to each first live streaming user according to the information about the display area of each first live streaming user includes: determining, in response to currently displaying UI elements of a plurality of second live streaming users, whether a live streaming user corresponding to each display area changes, according to the information about the display area of each first live streaming user and information about a display area of each second live streaming user of the plurality of second live streaming users; and for each display area, randomly generating, in response to the live streaming user corresponding to the display area changes, the first display position of the first live streaming user corresponding to the display area in the display area.

If the client is currently displaying the UI elements of the plurality of second live streaming users, the client may determine whether the live streaming user corresponding to each display area has changed, and randomly generate the first display positions of the first live streaming user only for the display area in which a change has occurred. During display, the client may only update the UI element of the first live streaming user in the display area in which the change has occurred, so that the live streaming users and the audiences may more intuitively see which live streaming users have changed in ranking of the audio quality information.

Some transition effects may be added when the UI elements of the plurality of first live streaming users are displayed. In some embodiments, displaying the UI element of each first live streaming user at the first display position corresponding to each first live streaming user includes: in response to currently displaying UI elements of a plurality of second live streaming users, displaying an effect that the UI elements of the plurality of second live streaming users disappear, and displaying an effect that the UI element of each first live streaming user appears at the first display position corresponding to each first live streaming user.

It is also possible to only display an effect that the UI element of the second live streaming user in the display area in which the change has occurred disappears and the UI element of the first live streaming user appears. Certainly, other effects may be used to reflect the switch between the UI element of the second live streaming user and the UI element of the first live streaming user. For example, the UI element of the second live streaming user flies out and the UI element of the first live streaming user flies in, which is not limited to the examples shown.

With addition of some transition and switching effects, a live streaming user and an audience may more intuitively and accurately see that display information of the live streaming users has changed, thereby improving the display effect.

In addition to displaying the UI element of each first live streaming user, some effects may also be added for part or all first live streaming users, so that information displayed on the display interface is richer and more diverse, thereby improving the display effect. In some embodiments, the live streaming processing method further includes: determining one or more third live streaming users from the plurality of first live streaming users and one or more effects corresponding to each third live streaming user of the one or more third live streaming users. Displaying the UI element of each first live streaming user at the first display position corresponding to each first live streaming user includes: displaying, at a first display position corresponding to each third live streaming user, the UI element of each third live streaming user and adding the one or more effects corresponding to each third live streaming user.

For example, the client may receive effect indication information sent by the server, and the effect indication information may include a user identification of one or more third live streaming users to whom effects need to be added and an identification of one or more effects. For each third live streaming user, the one or more effects may be configured by the third live streaming user, or may be determined by the server according to a specific rule, for example, determined by the server according to the audio quality information of the one or more third live streaming users. For another example, the client may receive the audio quality information of the plurality of first live streaming users sent by the server, and determine one or more third live streaming users and one or more effects corresponding to each third live streaming user according to the audio quality information.

For example, the one or more effects may include making an avatar of the third live streaming user move in a specific manner, for example, shake or spin in the display area. For example, the one or more effects may include adding elements such as a halo, a light wave, a star, and a crown on the avatar of the third live streaming user, and these elements may be of different colors and may be static or dynamic, which is not limited to the examples shown.

According to the method in the above embodiments, one or more effects are added to the one or more UI elements of one or more third live streaming users, so that the content displayed on the display interface of the interactive live streaming may be richer and more diverse, and the one or more UI elements of the one or more third live streaming users are more vivid, thereby improving the display effect.

The one or more third live streaming users and the one or more effects corresponding to each third live streaming user may be determined according to the audio quality information of each first live streaming user. In some embodiments, the live streaming processing method further includes: obtaining a quality score of each first live streaming user determined based on the audio quality information of each first live streaming user. Determining one or more third live streaming users from the plurality of first live streaming users and one or more effects corresponding to each third live streaming user of the one or more third live streaming users includes: determining the one or more third live streaming users and the one or more effects corresponding to each third live streaming user according to the quality score of each first live streaming user, where third live streaming users with different quality scores correspond to different effects.

The quality score of each first live streaming user may be determined by the server based on the audio quality information of each first live streaming user, and the client receives the quality score of each first live streaming user. The client may also determine the quality score of each first live streaming user based on the audio quality information of each first live streaming user. For example, the client determines an evaluation grade of each first live streaming user according to the quality score of each first live streaming user, and determines the one or more third live streaming users and the one or more effects corresponding to each third live streaming user according to the evaluation grade. For example, at least one of the numbers or the styles of the effects corresponding to the third live streaming users with different evaluation grades are different. For example, the third live streaming user with the highest evaluation grade may correspond to three effects, including a light wave effect, a flashing effect, and an effect of displaying an element with the word “PERFECT”. For another example, the effect corresponding to a third live streaming user with a high evaluation grade is “PERFECT”, and the effect corresponding to a third live streaming user with a low evaluation grade is “GOOD”, etc., which is not limited to the examples shown.

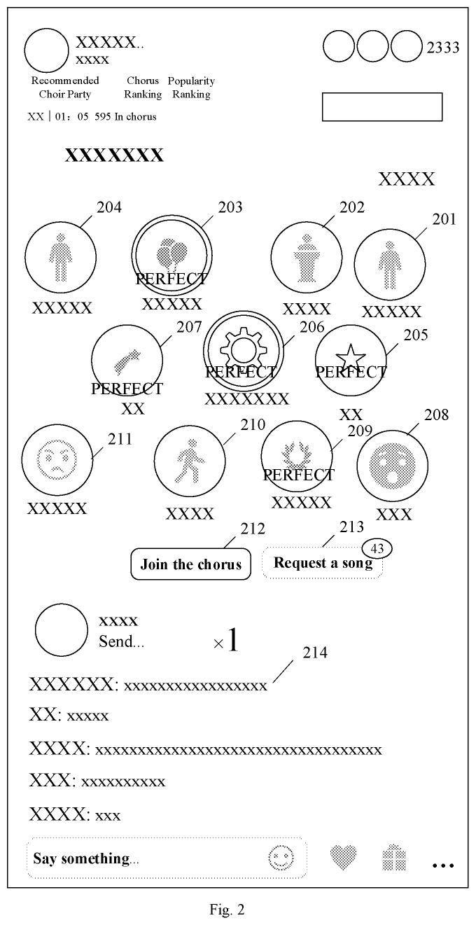

Taking the interactive live streaming as live streaming chorus for an example, a plurality of live streaming users may sing according to lyrics displayed on the display interface and accompaniment music being played, and the audio streams of the plurality of live streaming users are merged and broadcast, thereby presenting a chorus effect. As shown in FIG. 2, the UI elements 201 to 211 of the plurality of first live streaming users may be displayed on the display interface of the live streaming chorus, which may include the avatars, names, etc. of the first live streaming users. Effects may also be added for one or more third live streaming users, such as a light wave effect and an effect of “PERFECT”. A control 212 for joining a chorus and a control 213 for requesting a song may also be displayed on the display interface, and messages 214, etc. sent by the audience while watching the interactive live streaming may also be displayed on the display interface.

There may be some differences in the content on the display interface between a live streaming user and an audience. For example, the display interface on the live streaming user side may also display real-time singing progress, real-time scores, etc. of the song, which is not limited to the examples shown.

According to the method in the above embodiments, one or more third live streaming users are selected according to the audio quality information of the plurality of first live streaming users, and different effects may be displayed for the third live streaming users with different audio qualities, so that the content displayed on the display interface of the interactive live streaming is richer, more vivid, and more intuitive, and the live streaming users and the audiences may more intuitively and accurately see the audio quality, interaction, etc. of different third live streaming users, thereby improving the display effect of the display interface and better meeting the viewing requirement. In addition, adding effects for one or more third live streaming users according to the audio quality information may improve the enthusiasm of the live streaming users for interaction, thereby improving the quality of the entire interactive live streaming.

A specific animation effect may also be executed for part or all of the plurality of first live streaming users. In some embodiments, the live streaming processing method further includes: obtaining indication information of executing a specific animation effect for one or more fourth live streaming users from the plurality of first live streaming users, wherein audio quality information of the one or more fourth live streaming users reaches a specific standard; and displaying UI elements of the one or more fourth live streaming users according to the indication information and the specific animation effect.

In the case of a plurality of fourth live streaming users, the specific animation effect may be completed by joint movement of the UI elements of the plurality of fourth live streaming users. The client may obtain from the server the indication information of executing the specific animation effect for the one or more fourth live streaming users, and the indication information may include one or more user identifications of the one or more fourth live streaming users and an identification of the specific animation effect, or the indication information includes the identification of the specific animation effect, and the one or more fourth live streaming users are determined by the client.

For example, the specific animation effect includes that the one or more UI elements of the one or more fourth live streaming users move to a specific display position, e.g., the one or more UI elements of the one or more fourth live streaming users move from the one or more first display positions to the center area of the screen and forms a specific arrangement order. For another example, the one or more UI elements of the one or more fourth live streaming users move according to a specific trail, e.g., the UI elements of the plurality of fourth live streaming users enclose a circle and move according to a trail of the circle. For another example, the UI elements of the plurality of fourth live streaming users collide with each other and a specific effect element is displayed, which is not limited to the examples shown above.

According to the method in the above embodiments, the specific animation effect is executed for the one or more UI elements of the one or more fourth live streaming users, so that the content displayed on the display interface of the interactive live streaming is richer, more vivid, and more intuitive, and the one or more fourth live streaming users are determined according to the audio quality information, and the specific animation effect is executed for these fourth live streaming users, and the live streaming users and the audiences may more intuitively and accurately see the audio quality, interaction, etc. of different fourth live streaming users, thereby improving the display effect of the display interface and better meeting the viewing requirement. In addition, executing the specific animation effect for the one or more fourth live streaming users according to the audio quality information may improve the enthusiasm of the live streaming users for interaction, thereby improving the quality of the entire interactive live streaming.

In some embodiments, displaying the UI elements of the one or more fourth live streaming users according to the indication information and the specific animation effect includes: determining the one or more fourth live streaming users from the plurality of first live streaming users according to the indication information and the first display position corresponding to each first live streaming user; determining, according to a first display position corresponding to each fourth live streaming user, a second display position corresponding to each fourth live streaming user in the specific animation effect; and moving the UI element of each fourth live streaming user from the first display position corresponding to each fourth live streaming user to the second display position corresponding to each fourth live streaming user to present the specific animation effect.

The client may select one or more fourth live streaming users whose first display position is in a specific display area. For example, the client may select a plurality of fourth live streaming users in display areas numbered 1, 2, and 3. Alternatively, the indication information includes the quality score of each first live streaming user determined based on the audio quality information of each first live streaming user, and the client selects one or more first live streaming users whose quality score is at a preset level or higher than a threshold as the one or more fourth live streaming users.

The client determines the one or more second display positions corresponding to the one or more fourth live streaming users in the specific animation effect, and displays the specific animation effect of the one or more UI elements of the one or more fourth live streaming users moving from the one or more first display positions to the one or more second display positions. The specific animation effect may also include displaying a specific effect element, for example, displaying an element such as “PERFECT”.

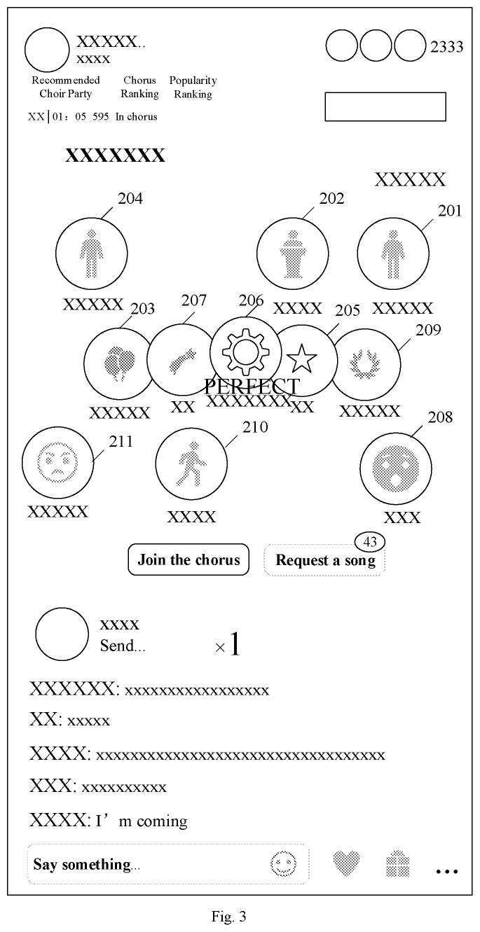

As shown in FIG. 3, the UI elements 203, 205, 206, 207, and 209 of the fourth live streaming users move to the center area and form a specific arrangement, and the element “PERFECT” is displayed, thereby presenting a specific animation effect.

For example, after the UI element of each first live streaming user is displayed, the specific animation effect corresponding to the one or more UI elements of the one or more fourth live streaming users are switchingly displayed at the first display position corresponding to each first live streaming user.

According to the method in the above embodiments, the display interface of the interactive live streaming may be made more interesting, and the enthusiasm of the live streaming users to participate in the interactive live streaming may be improved, thereby improving the display effect of the entire display interface.

In some embodiments, the audio quality information of each first live streaming user includes quality information determined based on at least one of an audio attribute, a communication parameter, or audience feedback information of each first live streaming user.

For example, the audio attribute includes audio content, and the quality information may be determined according to understanding of the audio content of each first live streaming user. For example, the quality information is determined according to the relevance between the audio content and a specific theme or content. The higher the relevance between the audio content and the specific theme or content, the better the quality.

For example, the audio attribute further includes at least one element such as volume, tone, pitch, timbre, or rhythm, which is not limited to the examples shown. One or more elements may be matched with a specific standard to determine the quality information. For example, one or more elements of singing data of each first live streaming user are scored as the quality information.

For example, the communication parameter includes at least one of network delay, signal quality, or noise, etc., which is not limited to the examples shown. For example, the greater the network delay, the worse the signal quality, and the greater the noise, the worse the audio quality. Generally, a live streaming user wearing a headset may indicate low noise.

For example, the audience feedback information includes at least one of the number of views, the number of likes, the number of comments, the number of gifts received, etc. of the first live streaming users, which is not limited to the examples shown. Higher audience feedback may indicate better audio quality.

Based on the method in the embodiments described above, the audio quality information of each first live streaming user is considered and determined from one or more perspectives, so that the accuracy may be improved, and the method is better matched with the scenario of interactive live streaming and meets the viewing requirements of the live streaming users and the audiences better. In addition, for the audience side, only the merged stream of the audio streams of the first live streaming users may be pushed, thereby reducing interference of other live streaming users. For a live streaming user, a merged stream of the audio stream of the live streaming user and the audio streams of the first live streaming users needs to be pushed.

In some embodiments, the interactive live streaming is live streaming chorus, and the audio of each first live streaming user includes singing audio of each first live streaming user.

In the live streaming chorus scenario, according to the method in the above embodiments, the UI element of a first live streaming user with good audio quality and good performance in the chorus may be displayed, and the UI elements displayed on the chorus interface are dynamic, which is better adapted to the live streaming chorus scenario, improves the interaction effect of the live streaming chorus, better meets the requirements of the live streaming users and the audience, and improves the display effect as a whole.

In some embodiments, in a case where the client is a client of a live streaming user of the interactive live streaming, in response to the live streaming user not belonging to the plurality of first live streaming users, a certain first live streaming user is replaced with the live streaming user, and the UI element of the live streaming user and the UI elements of other first live streaming users (except the replaced first live streaming user) are displayed on the client of the live streaming user.

According to the method in the above embodiments, the viewing experience of the live streaming users may be improved, and the willingness of the live streaming users to participate in the interaction may be improved.

A live streaming processing method performed by a server is described below.

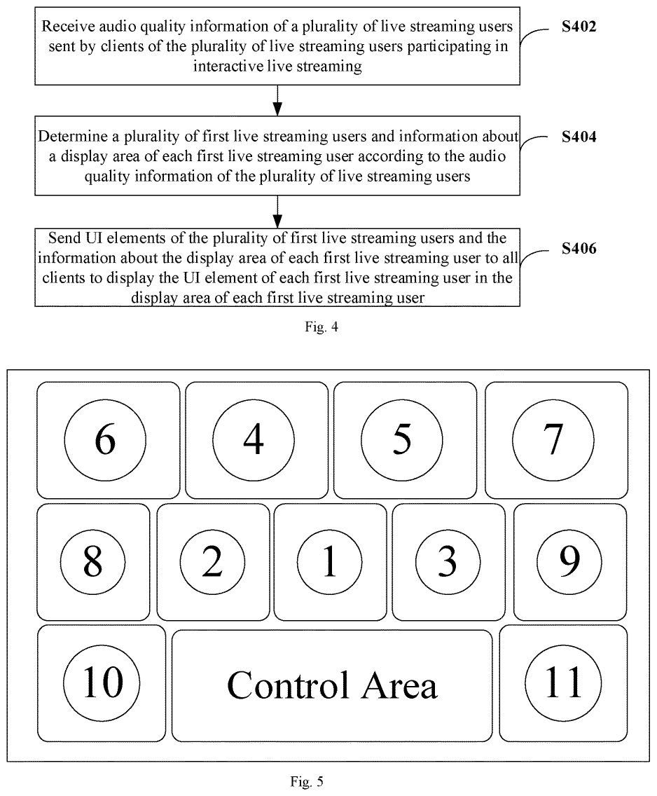

FIG. 4 is a flowchart of some embodiments of a live streaming processing method according to the present disclosure. As shown in FIG. 4, the method in these embodiments includes steps S402 to S406. The method in these embodiments may be performed by a server.

In step S402, audio quality information of a plurality of live streaming users sent by clients of the plurality of live streaming users participating in interactive live streaming is received.

For example, each live streaming user may periodically send to the server the audio quality information of the live streaming user of the client.

In step S404, a plurality of first live streaming users and information about a display area of each first live streaming user are determined according to the audio quality information of the plurality of live streaming users, where the plurality of first live streaming users are part or all of the plurality of live streaming users, and audio streams of the plurality of first live streaming users are output as a merged stream in the interactive live streaming.

In step S406, user interface (UI) elements of the plurality of first live streaming users and the information about the display area of each first live streaming user are send to all clients to display the UI element of each first live streaming user in the display area of each first live streaming user.

In one period, the client first determines the audio quality information of the live streaming user of the client within a preset time and sends the audio quality information to the server, the server determines the plurality of first live streaming users and the information about the display area of each first live streaming user and sends the UI element of each first live streaming user and the information about the display area of each first live streaming user to the client, and the client displays the UI element of each first live streaming user.

In the live streaming processing method in the embodiments described above, the server obtains the audio quality information of each live streaming user, determines the plurality of first live streaming users and the information about the display area of each first live streaming user according to the audio quality information, and sends the UI elements of each first live streaming user and the information about the display area of each first live streaming user to the client, and the UI elements are displayed by the client. Since the plurality of first live streaming users and the information about the display area of each first live streaming user are determined according to the audio quality information of each first live streaming user, and the real-time interaction of the plurality of live streaming users may lead to the changes in the audio quality information, the plurality of first live streaming users and the display areas thereof may also change with the audio quality information. Thus, the information displayed on the display interface of the interactive live streaming is more effective, matches the real-time interactivity of the interactive live streaming, and meets the viewing requirements of the live streaming users or the audience better. The participation states and the participation effects of the live streaming users in the interactive live streaming are displayed more vividly, and the overall display effect of the interface of the interactive live streaming is improved.

How to determine the plurality of first live streaming users and the information about the display area of each first live streaming userof the plurality of first live streaming users is specifically described below.

In some embodiments, determining the plurality of first live streaming users and the information about the display area of each first live streaming user of the plurality of first live streaming users according to the audio quality information of the plurality of live streaming users includes: determining, according to the number of a plurality of display areas in an interface of the interactive live streaming and the audio quality information of the plurality of live streaming users, the plurality of first live streaming users equal in number to the plurality of display areas; and determining a correspondence between the plurality of first live streaming users and the plurality of display areas according to the audio quality information of the plurality of first live streaming users to obtain the information about the display area of each first live streaming user.

As shown in FIG. 5, the display interface of the interactive live streaming may include 11 display areas, and the closer the display area is to the center, the higher the attention to the display area. For example, the display area No. 1 receives the highest attention. The information about the display areas of the plurality of first live streaming users may be determined according to the audio quality information of the plurality of first live streaming users. For example, the better the audio quality of a first live streaming user, the higher the attention to the display area corresponding to the first live streaming user.

According to the method in the above embodiments, the display areas of the plurality of first live streaming users may be more accurately and reasonably determined, and the method is better adapted to the scenario of interactive live streaming, thereby improving the display effect.

In some embodiments, the audio quality information of each live streaming user of the plurality of live streaming users includes a plurality of items of quality information, and determining the plurality of first live streaming users and the information about the display area of each first live streaming user of the plurality of first live streaming users according to the audio quality information of the plurality of live streaming users includes: determining a weight corresponding to each item of quality information of the plurality of items of quality information according to a scenario type corresponding to the interactive live streaming; determining a quality score of each live streaming user according to the plurality of items of quality information of each live streaming user and the weight corresponding to each item of quality information; and determining the plurality of first live streaming users and the information about the display area of each first live streaming user according to the quality score of each live streaming user.

For example, the plurality of items of quality information include a first evaluation determined based on audio content, a second evaluation determined based on the one or more elements, a third evaluation determined based on a communication parameter, and a fourth evaluation determined based on audience feedback information. Further division may be made. For example, the communication parameter includes network delay and noise, a fifth evaluation may be determined according to the network delay, and a sixth evaluation may be determined according to the noise. The fifth evaluation and sixth evaluation may replace the third evaluation. The other items of quality information may also be further divided, which will not be repeated.

The weights corresponding to the items of quality information may be different for different scenario types. For example, for a scenario that requires more communication and conversation between live streaming users, the third evaluation determined based on the communication parameter has a higher weight, otherwise the communication information cannot be clearly heard. For a general chorus scenario, the second evaluation determined based on the one or more elements has a higher weight, which is not limited to the examples shown.

According to the method in the above embodiments, the plurality of first live streaming users and the information about the display area of each first live streaming user may be more effectively and accurately determined for different scenarios, thereby adapting to different scenarios and improving the display effect.

In some embodiments, determining the plurality of first live streaming users and the information about the display area of each first live streaming user of the plurality of first live streaming users according to the audio quality information of the plurality of live streaming users includes: determining the plurality of first live streaming users and the information about the display area of each first live streaming user according to the audio quality information of the plurality of users and role information of the plurality of users in the interactive live streaming.

Different roles may be provided for the live streaming users in the interactive live streaming, such as a lead singer and a host. These specific roles may correspond to display areas at fixed positions to avoid that the live streaming users with these specific roles cannot be displayed.

The plurality of methods for determining the plurality of first live streaming users and the information about the display area of each first live streaming user may be applied in combination with each other, which will not be repeated.

In some embodiments, sending the UI elements of the plurality of first live streaming users and the information about the display area of the plurality of first live streaming users to all clients includes: for each client of all clients, in response to the client entering a live channel of the interactive live streaming, sending the UI elements of the plurality of first live streaming users and the information about the display area of each first live streaming user to the client; and/or after determining the plurality of first live streaming users and the information about the display area of each first live streaming user in a current period, sending the information about the display area of each first live streaming user to all clients.

The server may send the information about the plurality of first live streaming users and the information about the display area of each first live streaming user to the client at different stages, thereby improving the accuracy of display.

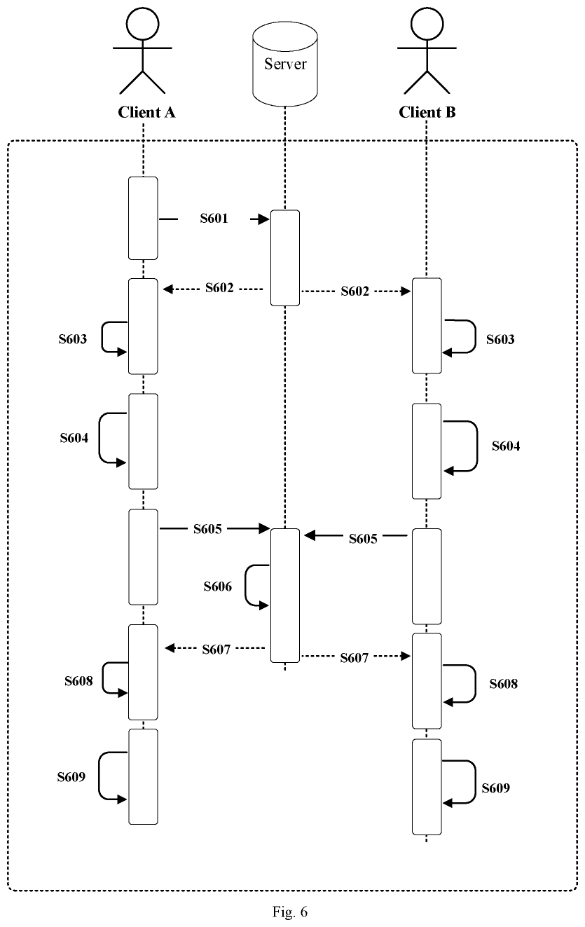

A procedure of interaction between a client, which is a client of a live streaming user, and a server is described below with reference to FIG. 6.

FIG. 6 is a flowchart of some embodiments of a live streaming processing method according to the present disclosure. As shown in FIG. 6, the method in these embodiments includes steps S601 to S609. Step S601 is performed by the client A, and the other steps may be performed by both the clients A and B.

In step S601, a client sends a message to a server to request to join interactive live streaming.

A live streaming user of the client may join an interactive chorus and send the message to the server to request to join the interactive live streaming, where the message may include a user identification of the live streaming user.

In step S602, the server sends a Webcast Room Data Sync (WRDS) message to each client.

The WRDS message sent to the client that joins the interactive live streaming includes information about UI elements and display areas of currently displayed live streaming users and information about a UI element and a display area of the client. Sending the WRDS message to other clients may include the information about the UI element and the display area of the client that joins the interactive live streaming, or certainly, the content of the WRDS message may be the same as that of the WRDS message sent to the client that joins the interactive live streaming.

In step S603, the client determines, according to the WRDS message, information about a plurality of currently displayed live streaming users and a display area of each live streaming user, and generates display positions of the plurality of currently displayed live streaming users.

In step S604, the client displays UI elements of the plurality of currently displayed live streaming users according to the display positions of the plurality of currently displayed live streaming users.

In step S605, the client sends audio quality information to the server, in response to determining audio quality information of the live streaming user of the client.

In step S606, a server determines, according to the audio quality information sent by each client, information about the plurality of currently displayed live streaming users and the display area of each live streaming user.

In step S607, the server sends a WRDS message to each client.

The WRDS message sent to each client includes information about UI elements and display areas of the plurality of currently displayed live streaming users.

In step S608, the client determines, according to the WRDS message, the information about the plurality of currently displayed live streaming users and the display area of each live streaming user, and generates display positions of the plurality of currently displayed live streaming users.

In step S609, the client displays the UI elements of the plurality of currently displayed live streaming users according to the display positions of the plurality of currently displayed live streaming users.

According to the procedure in the above embodiments, the UI elements of the live streaming users may be dynamically displayed according to the audio quality information of each live streaming user, and the accuracy of display and the display effect are improved.

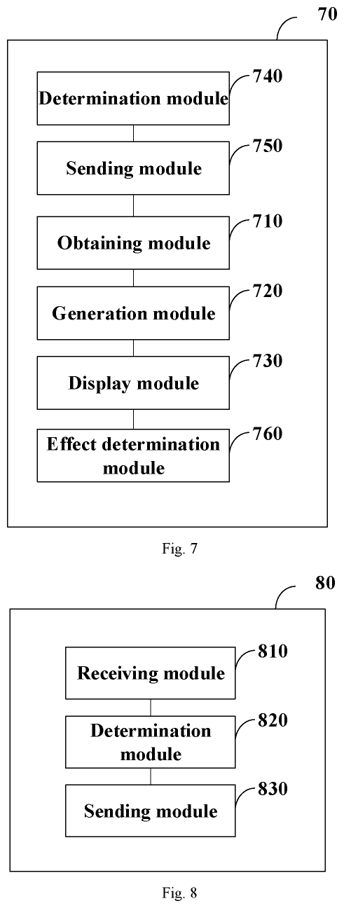

The present disclosure further provides a client, which is described below with reference to FIG. 7.

FIG. 7 is a diagram of structures of some embodiments of a client according to the present disclosure. As shown in FIG. 7, the client 70 in these embodiments includes: an obtaining module 710, a generation module 720 and a display module 730.

The obtaining module 710 is configured to obtain user interface (UI) elements and information about display areas of a plurality of first live streaming users participating in interactive live streaming, wherein audio streams of the plurality of first live streaming users are output as a merged stream in the interactive live streaming, and the plurality of first live streaming users and the information about the display area of each first live streaming user of the plurality of first live streaming users are determined according to audio quality information of the each first live streaming user.

The generation module 720 is configured to generate a first display position corresponding to the each first live streaming user according to the information about the display area of the each first live streaming user.

The display module 730 is configured to displaying the UI element of the each first live streaming user at the first display position corresponding to the each first live streaming user.

According to the client in the embodiments described above, the UI elements and the information about the display areas of the plurality of first live streaming users participating in the interactive live streaming may be obtained, the first display position corresponding to each first live streaming user may be generated according to the information about the display area of each first live streaming user, and the UI element of each first live streaming user may be displayed at the first display position corresponding to each first live streaming user. Since the plurality of first live streaming users and the information about the display area of each first live streaming user are determined according to the audio quality information of each first live streaming user, and real-time interaction of a plurality of live streaming users may lead to changes in the audio quality information, the plurality of first live streaming users and the display areas thereof may also change with the audio quality information. Thus, information displayed on a display interface of the interactive live streaming is more effective, matches real-time interactivity of the interactive live streaming, and meets viewing requirements of the live streaming users or an audience better. Participation states and participation effects of the live streaming users in the interactive live streaming are displayed more vividly, and an overall display effect of the interface of the interactive live streaming is improved.

In some embodiments, the client 70 further includes: a determination module 740 configured to, determine, in response to the client being a client of a live streaming user participating in the interactive live streaming, audio quality information of the live streaming user according to audio data of the live streaming user in a current period; and a sending module 750 configured to send the audio quality information of the live streaming user to a server, wherein the plurality of first live streaming users and the display area of the each first live streaming user are determined by the server according to audio quality information of all live streaming users participating in the interactive live streaming, the plurality of first live streaming users being part or all live streaming users.

In some embodiments, the obtaining module 710 is configured to, receive, in response to a live streaming user or an audience of the client entering a live channel of the interactive live streaming, the UI elements and the information about the display areas of the plurality of first live streaming users sent by the server; and/or receive the UI elements and the information about the display areas of the plurality of first live streaming users sent by the server in a current period.

In some embodiments, the generation module 720 is configured to determine in response to currently displaying UI elements of a plurality of second live streaming users, whether a live streaming user corresponding to each display area of the display areas changes, according to the information about the display area of the each first live streaming user and information about a display area of each second live streaming user of the plurality of second live streaming users; and for the each display area, randomly generate, in response to the live streaming user corresponding to the display area changes, the first display position of the first live streaming user corresponding to the display area in the display area.

In some embodiments, the client 70 further includes an effect determination module 760 configured to determine one or more third live streaming users from the plurality of first live streaming users and one or more effects corresponding to each third live streaming user of the one or more third live streaming users. The display module 730 is configured to display, at a first display position corresponding to the each third live streaming user, the UI element of the each third live streaming user and adding the one or more effects corresponding to the each third live streaming user.

In some embodiments, the effect determination module 760 is further configured to obtain a quality score of the each first live streaming user determined based on the audio quality information of the each first live streaming user, determine the one or more third live streaming users and the one or more effects corresponding to the each third live streaming user according to the quality score of the each first live streaming user, wherein third live streaming users with different quality scores correspond to different effects.

In some embodiments, the obtaining module 710 is further configured to obtain indication information of executing a specific animation effect for one or more fourth live streaming users from the plurality of first live streaming users, wherein audio quality information of the one or more fourth live streaming users reaches a specific standard; and the display module 730 is further configured to display UI elements of the one or more fourth live streaming users according to the indication information and the specific animation effect.

In some embodiments, the display module 730 includes a first determination unit configured to determine the one or more fourth live streaming users from the plurality of first live streaming users according to the indication information and the first display position corresponding to the each first live streaming user, a second determination unit configured to determine, according to a first display position corresponding to each fourth live streaming user of the one or more fourth live streaming users, a second display position corresponding to the each fourth live streaming user in the specific animation effect; and a display unit configured to move the UI element of the each fourth live streaming user from the first display position corresponding to the each fourth live streaming user to the second display position corresponding to the each fourth live streaming user to present the specific animation effect.

In some embodiments, the audio quality information of the each first live streaming user comprises quality information determined based on at least one of an audio attribute, a communication parameter, or audience feedback information of the each first live streaming user.

In some embodiments, the interactive live streaming is a live streaming chorus, and the audio of the each first live streaming user comprises singing audio of the each first live streaming user.

The client may implement the method performed by the client in the embodiments described above, and achieve the same or similar technical effects, which will not be repeated. The client may be provided in an electronic device such as a user terminal, which will not be repeated.

The present disclosure further provides a server, which is described below with reference to FIG. 8.

FIG. 8 is a diagram of structures of some embodiments of a server according to the present disclosure. As shown in FIG. 8, the server 80 in these embodiments includes: a receiving module 810, a determination module 820, and a sending module 830.

The receiving module 810 is configured to receive audio quality information of a plurality of live streaming users sent by clients of the plurality of live streaming users participating in interactive live streaming.

The determination module 820 is configured to determine a plurality of first live streaming users and information about a display area of the each first live streaming user of the plurality of live streaming users according to the audio quality information of the plurality of live streaming users, wherein the plurality of first live streaming users are part or all of the plurality of live streaming users, and audio streams of the plurality of first live streaming users are output as a merged stream in the interactive live streaming.

The sending module 830 is configured to send user interface (UI) elements of the plurality of first live streaming users and the information about the display area of the each first live streaming user to all clients to display the UI element of the each first live streaming user in the display area of the each first live streaming user.

According to the server in the embodiments described above, the audio quality information of each live streaming user may be obtained, the plurality of first live streaming users and the information about the display area of each first live streaming user may be determined according to the audio quality information, and the UI elements of each first live streaming user and the information about the display area of each first live streaming user may be sent to the client, and the UI elements are displayed by the client. Since the plurality of first live streaming users and the information about the display area of each first live streaming user are determined according to the audio quality information of each first live streaming user, and real-time interaction of the plurality of live streaming users may lead to changes in the audio quality information, the plurality of first live streaming users and the display areas thereof may also change with the audio quality information. Thus, information displayed on a display interface of the interactive live streaming is more effective, matches real-time interactivity of the interactive live streaming, and meets viewing requirements of the live streaming users or an audience better. Participation states and participation effects of the live streaming users in the interactive live streaming are displayed more vividly, and an overall display effect of the interface of the interactive live streaming is improved.

In some embodiments, the determination module 820 is configured to determine, according to the number of a plurality of display areas in an interface of the interactive live streaming and the audio quality information of the plurality of live streaming users, the plurality of first live streaming users equal in number to the plurality of display areas; and determine according to the audio quality information of the plurality of first live streaming users, a correspondence between the plurality of first live streaming users and the plurality of display areas to obtain the information about the display area of the each first live streaming user.

In some embodiments, the audio quality information of the each live streaming user of the plurality of live streaming users comprises a plurality of items of quality information, and the determination module 820 is configured to determine a weight corresponding to each item of quality information of the plurality of items of quality information according to a scenario type corresponding to the interactive live streaming; determine a quality score of the each live streaming user according to the plurality of items of quality information of the each live streaming user and the weight corresponding to the each item of quality information; and determine the plurality of first live streaming users and the information about the display area of the each first live streaming user according to the quality score of the each live streaming user.

In some embodiments, the determination module 820 is configured to determine the plurality of first live streaming users and the information about the display area of the each first live streaming user according to the audio quality information of the plurality of live streaming users and role information of the plurality of live streaming users in the interactive live streaming.

In some embodiments, the sending module 830 is configured to, for each client of all clients, send the UI elements of the plurality of first live streaming users and the information about the display area of the each first live streaming user to the client, in response to the client entering a live channel of the interactive live streaming; and/or send the information about the display area of the each first live streaming user to all clients, after determining the plurality of first live streaming users and the information about the display area of the each first live streaming user in a current period.

The server may implement the method performed by the server in the embodiments described above, and achieve the same or similar technical effects, which will not be repeated. The server may be provided in an electronic device such as a server, which will not be repeated.

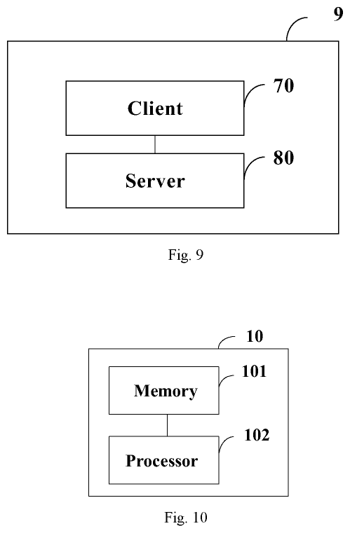

The present disclosure further provides a live streaming processing system, which is described below with reference to FIG. 9.

FIG. 9 is a diagram of structures of some embodiments of a live streaming processing system according to the present disclosure. As shown in FIG. 9, the system 9 in these embodiments includes: a client 70 and a server 80.

For the client 70 and the server 80, reference may be made to the embodiments described above,

### Which Will Not Be Repeated.

According to the live streaming processing system in the embodiments described above, the client sends the audio quality information of each live streaming user to the server, the server determines the plurality of first live streaming users and the information about the display area of each first live streaming user according to the audio quality information, and sends the UI elements of each first live streaming user and the information about the display area of each first live streaming user to the client, and the UI elements are displayed by the client. Since the plurality of first live streaming users and the information about the display area of each first live streaming user are determined according to the audio quality information of each first live streaming user, and real-time interaction of the plurality of live streaming users may lead to changes in the audio quality information, the plurality of first live streaming users and the display areas thereof may also change with the audio quality information. Thus, information displayed on a display interface of the interactive live streaming is more effective, matches real-time interactivity of the interactive live streaming, and meets viewing requirements of the live streaming users or an audience better. Participation states and participation effects of the live streaming users in the interactive live streaming are displayed more vividly, and an overall display effect of the interface of the interactive live streaming is improved.

The present disclosure further provides an electronic device. The electronic device includes: a processor; and a memory coupled to the processor and configured to store instructions. The instructions, when executed by the processor, cause the processor to perform the live streaming processing method according to any one of the embodiments of the present disclosure.

According to the electronic device of the present disclosure, the plurality of first live streaming users and the information about the display area of each first live streaming user may be determined according to the audio quality information of each live streaming user, and then the UI elements of each first live streaming user may be displayed. Since the plurality of first live streaming users and the information about the display area of each first live streaming user are determined according to the audio quality information of each first live streaming user, and real-time interaction of a plurality of live streaming users may lead to changes in the audio quality information, the plurality of first live streaming users and the display areas thereof may also change with the audio quality information. Thus, information displayed on a display interface of the interactive live streaming is more effective, matches real-time interactivity of the interactive live streaming, and meets viewing requirements of the live streaming users or an audience better. Participation states and participation effects of the live streaming users in the interactive live streaming are displayed more vividly, and an overall display effect of the interface of the interactive live streaming is improved.

The present disclosure further provides a computer-readable storage medium having a computer program stored thereon, where the program, when executed by a processor, implements the live streaming processing method according to any one of the embodiments of the present disclosure.

According to the computer-readable storage medium of the present disclosure, the plurality of first live streaming users and the information about the display area of each first live streaming user may be determined according to the audio quality information of each live streaming user, and then the UI elements of each first live streaming user may be displayed. Since the plurality of first live streaming users and the information about the display area of each first live streaming user are determined according to the audio quality information of each first live streaming user, and real-time interaction of the plurality of live streaming users may lead to changes in the audio quality information, the plurality of first live streaming users and the display areas thereof may also change with the audio quality information. Thus, information displayed on a display interface of the interactive live streaming is more effective, matches real-time interactivity of the interactive live streaming, and meets viewing requirements of the live streaming users or an audience better. Participation states and participation effects of the live streaming users in the interactive live streaming are displayed more vividly, and an overall display effect of the interface of the interactive live streaming is improved.

FIG. 10 is a block diagram of an electronic device according to some embodiments of the present disclosure.

The memory 101 is used to store one or more computer-readable instructions. The memory 101 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. The memory 101 may store, for example, an operating system, applications, a boot loader, databases, and other programs, and may also store various applications, various data, etc.

The processor 102 is used to run the computer-readable instructions to implement the method in any one of the embodiments described above. For the specific implementation of each step of the method, reference may be made to the embodiments described above, and details of the same parts are not repeated.

The processor 102 may be configured to perform the steps in the method according to any one of the embodiments of the present disclosure. The processor 102 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may have an X86 or ARM architecture or the like.

The processor 102 and the memory 101 may directly or indirectly communicate with each other. For example, the processor 102 and the memory 101 may communicate through a network. The network may include a wireless network, a wired network, and/or any combination of a wireless network and a wired network. The processor 102 and the memory 101 may also communicate with each other through a system bus, which is not limited in the present disclosure.

It should be noted that the components of the electronic device 10 shown in FIG. 10 are merely exemplary and non-restrictive, and the electronic device 10 may have other components according to actual application requirements. The processor 102 may control other components in the electronic device 10 to perform desired functions.

The electronic device 10 may be implemented by means of software, firmware, and/or hardware, and may be integrated into apparatuses installed with related applications.

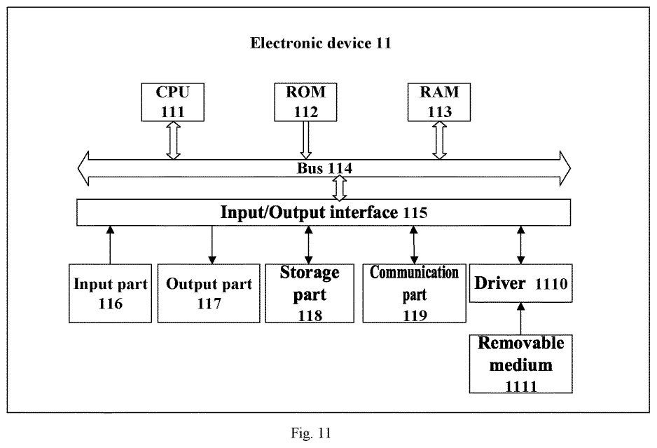

The electronic device of the present disclosure is described hereinafter with reference to FIG. 11. FIG. 11 is a block diagram of an electronic device according to some other embodiments of the present disclosure.

The electronic device 11 shown in FIG. 11 may be a computer system having a dedicated hardware structure, and may perform corresponding functions when installed with related applications.

The electronic device includes, but is not limited to, mobile terminals such as smartphones, notebook computers, personal digital assistants (Personal Digital Assistant, PDA), tablet personal computers (Tablet Personal Computer, Tablet PC), portable multimedia players (PMP), vehicle terminals (e.g., car navigation terminal), wearable devices, etc., and fixed terminals such as digital TVs, desktop computers, etc.

As shown in FIG. 11, a central processing unit (CPU) 111 performs various processes according to a program stored in a read-only memory (ROM) 112 or a program loaded from a storage unit 118 into a random access memory (RAM) 113. The RAM 113 stores data required when the CPU 111 performs various processes and the like as needed. The central processing unit is merely exemplary, and other types of processors, such as the various processors described above, may be used. The ROM 112, the RAM 113, and the storage unit 118 may be various forms of computer-readable storage media. It should be noted that although the ROM 112, the RAM 113, and the storage unit 118 are shown separately in FIG. 11, one or more of them may be combined or located in the same or different memories or storage modules.

The CPU 111, the ROM 112, and the RAM 113 are connected to each other via a bus 114. An input/output interface 115 is also connected to the bus 114.

The following components are connected to the input/output interface 115: an input unit 116, such as a touch screen, a touchpad, a keyboard, a mouse, an image sensor, a microphone, an accelerometer, a gyroscope, etc. ; an output unit 117, including a display such as a cathode ray tube (CRT), a liquid crystal display (LCD), a speaker, a vibrator, etc. ; the storage unit 118, including a hard disk, a magnetic tape, etc.; and a communication unit 119, including a network interface card such as a LAN card, a modem, etc. The communication unit 119 allows communication processing to be performed via a network such as Internet. It is easy to understand that although some components in the electronic device 11 are shown in FIG. 11 to communicate through the bus 114, they may also communicate through a network or other means, where the network may include a wireless network, a wired network, and/or any combination of a wireless network and a wired network.

A driver 1110 is also connected to the input/output interface 115 as needed. A removable medium 1111 such as a magnetic disk, an optical disc, a magneto-optical disc, a semiconductor memory, etc. is mounted on the driver 1110 as needed, so that a computer program read therefrom is installed into the storage unit 118 as needed.

In the case where the above series of processes are implemented by software, a program constituting the software may be installed from a network such as Internet or a storage medium such as the removable medium 1111.

According to the embodiments of the present disclosure, the processes described above with reference to the flowcharts may be implemented as computer software programs. For example, some embodiments of the present disclosure include a computer program product that, when running on a computer, causes the computer to implement the method according to any one of the embodiments described above. The computer program product includes computer instructions carried on a computer-readable medium, including program code for performing the method shown in the flowchart. In such an embodiment, the computer instructions may be downloaded and installed from a network via the communication unit 119, or installed from the storage unit 118, or installed from the ROM 112. When the computer program is executed by the CPU 111, the method according to the embodiments of the present disclosure is performed.

It should be noted that in the context of the present disclosure, a computer-readable medium may be a tangible medium that may contain or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electrical, magnetic, optical, electromagnetic, infrared, or semiconductor system, apparatus, or device, or any combination thereof. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. The computer-readable storage medium has computer instructions stored thereon, and the instructions, when executed by a processor, implement the method according to any one of the embodiments described above.

The computer-readable signal medium may include a data signal propagated on a baseband or as a part of a carrier, and computer-readable program code is carried thereon. This propagated data signal may take various forms, including, but not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program for use by or in combination with an instruction execution system, apparatus, or device. The program code contained on the computer-readable medium may be transmitted by any suitable medium, including, but not limited to, a wire, an optical cable, a radio frequency (RF), or any suitable combination thereof.

The above computer-readable medium may be included in the above electronic device, or may exist alone without being assembled into the electronic device.

In some embodiments, there is further provided a computer program, including: instructions that, when executed by a processor, cause the processor to implement the method according to any one of the embodiments described above. For example, the instructions may be embodied as computer program code.

In the embodiments of the present disclosure, the computer program code for performing the operations of the present disclosure may be written in one or more programming languages or a combination thereof, where the above programming languages include but are not limited to object-oriented programming languages, such as Java, Smalltalk, and C++, and further include conventional procedural programming languages, such as “C” language or similar programming languages. The program code may be executed entirely on a user's computer, partly on the user's computer, as a stand-alone software package, partly on the user's computer and partly on a remote computer, or entirely on the remote computer or server. In the case of involving a remote computer, the remote computer may be connected to the user's computer through any kind of network (including a local area network (LAN) or a wide area network (WAN)), or it may be connected to an external computer (for example, connected by using Internet provided by an Internet service provider).

The flowchart and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

What is claimed is

1. A live streaming processing method performed by a client and comprising:
obtaining user interface (UI) elements and information about display areas of a plurality of first live streaming users participating in interactive live streaming, wherein audio streams of the plurality of first live streaming users are output as a merged stream in the interactive live streaming, and the plurality of first live streaming users and the information about the display area of each first live streaming user of the plurality of first live streaming users are determined according to audio quality information of the each first live streaming user;
generating a first display position corresponding to the each first live streaming user according to the information about the display area of the each first live streaming user; and
displaying the UI element of the each first live streaming user at the first display position corresponding to the each first live streaming user.

2. The processing method of claim 1, further comprising:
determining, in response to the client being a client of a live streaming user participating in the interactive live streaming, audio quality information of the live streaming user according to audio data of the live streaming user in a current period; and
sending the audio quality information of the live streaming user to a server, wherein the plurality of first live streaming users and the display area of the each first live streaming user are determined by the server according to audio quality information of all live streaming users participating in the interactive live streaming, the plurality of first live streaming users being part or all live streaming users.

3. The processing method of claim 1, wherein the obtaining the UI elements and the information about the display areas of the plurality of first live streaming users participating in the interactive live streaming comprises:
receiving, in response to a live streaming user or an audience of the client entering a live channel of the interactive live streaming, the UI elements and the information about the display areas of the plurality of first live streaming users sent by the server; and/or receiving the UI elements and the information about the display areas of the plurality of first live streaming users sent by the server in a current period.

4. The processing method of claim 1, wherein the generating the first display position corresponding to the each first live streaming user according to the information about the display area of the each first live streaming user comprises:
determining, in response to currently displaying UI elements of a plurality of second live streaming users, whether a live streaming user corresponding to each display area of the display areas changes, according to the information about the display area of the each first live streaming user and information about a display area of each second live streaming user of the plurality of second live streaming users; and
for the each display area, randomly generating, in response to the live streaming user corresponding to the display area changes, the first display position of the first live streaming user corresponding to the display area in the display area.

5. The processing method of claim 1, further comprising:
determining one or more third live streaming users from the plurality of first live streaming users and one or more effects corresponding to each third live streaming user of the one or more third live streaming users;
wherein the displaying the UI element of the each first live streaming user at the first display position corresponding to the each first live streaming user comprises:
displaying, at a first display position corresponding to the each third live streaming user, the UI element of the each third live streaming user and adding the one or more effects corresponding to the each third live streaming user.

6. The processing method of claim 5, further comprising:
obtaining a quality score of the each first live streaming user determined based on the audio quality information of the each first live streaming user,
wherein the determining one or more third live streaming users from the plurality of first live streaming users and one or more effects corresponding to each third live streaming user of the one or more third live streaming users comprises:
determining the one or more third live streaming users and the one or more effects corresponding to the each third live streaming user according to the quality score of the each first live streaming user, wherein third live streaming users with different quality scores correspond to different effects.

7. The processing method of claim 1, further comprising:
obtaining indication information of executing a specific animation effect for one or more fourth live streaming users from the plurality of first live streaming users, wherein audio quality information of the one or more fourth live streaming users reaches a specific standard; and
displaying UI elements of the one or more fourth live streaming users according to the indication information and the specific animation effect.

8. The processing method of claim 7, wherein the displaying the UI elements of the one or more fourth live streaming users according to the indication information and the specific animation effect comprises:
determining the one or more fourth live streaming users from the plurality of first live streaming users according to the indication information and the first display position corresponding to the each first live streaming user;
determining, according to a first display position corresponding to each fourth live streaming user of the one or more fourth live streaming users, a second display position corresponding to the each fourth live streaming user in the specific animation effect; and
moving the UI element of the each fourth live streaming user from the first display position corresponding to the each fourth live streaming user to the second display position corresponding to the each fourth live streaming user to present the specific animation effect.

9. The processing method of claim 1, wherein:
the audio quality information of the each first live streaming user comprises quality information determined based on at least one of an audio attribute, a communication parameter, or audience feedback information of the each first live streaming user.

10. The processing method of claim 1, wherein the interactive live streaming is a live streaming chorus, and the audio of the each first live streaming user comprises singing audio of the each first live streaming user.

11. A live streaming processing method performed by a server and comprising:
receiving audio quality information of a plurality of live streaming users sent by clients of the plurality of live streaming users participating in interactive live streaming;
determining a plurality of first live streaming users and information about a display area of the each first live streaming user of the plurality of live streaming users according to the audio quality information of the plurality of live streaming users, wherein the plurality of first live streaming users are part or all of the plurality of live streaming users, and audio streams of the plurality of first live streaming users are output as a merged stream in the interactive live streaming; and
sending user interface (UI) elements of the plurality of first live streaming users and the information about the display area of the each first live streaming user to all clients to display the UI element of the each first live streaming user in the display area of the each first live streaming user.

12. The processing method of claim 11, wherein the determining a plurality of first live streaming users and information about a display area of the each first live streaming user of the plurality of first live streaming users according to the audio quality information of the plurality of live streaming users comprises:
determining, according to a number of a plurality of display areas in an interface of the interactive live streaming and the audio quality information of the plurality of live streaming users, the plurality of first live streaming users whose number is consistent with the number of the plurality of display areas; and
determining, according to the audio quality information of the plurality of first live streaming users, a correspondence between the plurality of first live streaming users and the plurality of display areas to obtain the information about the display area of the each first live streaming user.

13. The processing method of claim 11, wherein the audio quality information of the each live streaming user of the plurality of live streaming users comprises a plurality of items of quality information, and the determining a plurality of first live streaming users and information about a display area of the each first live streaming user of the plurality of first live streaming users according to the audio quality information of the plurality of live streaming users comprises:
determining a weight corresponding to each item of quality information of the plurality of items of quality information according to a scenario type corresponding to the interactive live streaming;
determining a quality score of the each live streaming user according to the plurality of items of quality information of the each live streaming user and the weight corresponding to the each item of quality information; and
determining the plurality of first live streaming users and the information about the display area of the each first live streaming user according to the quality score of the each live streaming user.

14. The processing method of claim 11, wherein the determining a plurality of first live streaming users and information about a display area of the each first live streaming user of the plurality of first live streaming users according to the audio quality information of the plurality of live streaming users comprises:
determining the plurality of first live streaming users and the information about the display area of the each first live streaming user according to the audio quality information of the plurality of live streaming users and role information of the plurality of live streaming users in the interactive live streaming.

15. The processing method of claim 11, wherein the sending the UI elements of the plurality of first live streaming users and the information about the display area of the plurality of first live streaming users to all clients comprises:
for each client of all clients, sending the UI elements of the plurality of first live streaming users and the information about the display area of the each first live streaming user to the client, in response to the client entering a live channel of the interactive live streaming; and/or sending the information about the display area of the each first live streaming user to all clients, after determining the plurality of first live streaming users and the information about the display area of the each first live streaming user in a current period.

16. An electronic device comprising:
one or more processors; and
one or more memories coupled to the one or more processors and configured to store instructions that, when executed by the one or more processors, cause the processor to:
obtain user interface (UI) elements and information about display areas of a plurality of first live streaming users participating in interactive live streaming, wherein audio streams of the plurality of first live streaming users are output as a merged stream in the interactive live streaming, and the plurality of first live streaming users and the information about the display area of each first live streaming user of the plurality of first live streaming users are determined according to audio quality information of the each first live streaming user;
generate a first display position corresponding to the each first live streaming user according to the information about the display area of the each first live streaming user; and
display the UI element of the each first live streaming user at the first display position corresponding to the each first live streaming user.

17. The electronic device according to claim 16, wherein the instructions when executed by the one or more processors, cause the processor to:
determine, in response to the client being a client of a live streaming user participating in the interactive live streaming, audio quality information of the live streaming user according to audio data of the live streaming user in a current period; and
send the audio quality information of the live streaming user to a server, wherein the plurality of first live streaming users and the display area of the each first live streaming user are determined by the server according to audio quality information of all live streaming users participating in the interactive live streaming, the plurality of first live streaming users being part or all live streaming users.

18. An electronic device comprising:
one or more processors; and
one or more memories coupled to the one or more processors and configured to store instructions that, when executed by the one or more processors, cause the processor to execute the live streaming processing method according to claim 11.

19. A non-transitory computer-readable storage medium having a computer program stored thereon, wherein the program, when executed by a processor, cause the processor to execute the live streaming processing method according to claim 1.

20. A non-transitory computer-readable storage medium having a computer program stored thereon, wherein the program, when executed by a processor, cause the processor to execute the live streaming processing method according to claim 11.
